(19) United States
(12) Patent Application Publication
(10) Pub. No.: US 2026/0149087 A1
(43) Pub. Date: May 28, 2026

(54) THERMAL INSULATION MATERIAL FOR BATTERY PACK AND MANUFACTURING METHOD THEREOF

(71) Applicant: Sumitomo Riko Company Limited, Aichi (JP)

(72) Inventors: Shigeaki Takamatsu, Aichi (JP); Yutaro Taguchi, Aichi (JP); Shota Hayashi, Aichi (JP)

(73) Assignee: Sumitomo Riko Company Limited, Aichi (JP)

(21) Appl. No.: 19/177,646

(22) Filed: Apr. 14, 2025

Related U.S. Application Data
(63) Continuation of application No. PCT/JP2024/033125, filed on Sep. 17, 2024.

(30) Foreign Application Priority Data
Sep. 21, 2023 (JP) 2023-155711

(51) Int. Cl. H01M 10/658; B28B 7/00; C01B 33/158; H01M 50/204

(52) U.S. Cl. CPC H01M 10/658; B28B 7/0097; C01B 33/1585; H01M 50/204

(57) ABSTRACT

A thermal insulation material for battery pack includes a pressure-molded body (1) of a composition having powder of a porous structure in which multiple primary particles are connected to form skeletons and which has pores between the skeletons. The porous structure is manufactured by a sol-gel reaction of a solution having two or more types of silane compounds with different numbers of siloxane bonds, and the powder of the porous structure includes particles (10) with different shapes and sizes obtained by subjecting the porous structure to a grinding process. The content of the powder of the porous structure in the composition is 65 mass % or more in a case where the solid content of the composition is 100 mass %, and the void ratio of the pressure-molded body (1) is 20% or less.

### CROSS-REFERENCE TO RELATED APPLICATION

The present application is a continuation of PCT/JP2024/033125, filed on Sep. 17, 2024, and is related to and claims priority from Japanese Patent Application No. 2023-155711 filed on Sep. 21, 2023. The entire contents of the aforementioned application are hereby incorporated by reference herein.

### TECHNICAL FIELD

The disclosure relates to a thermal insulation material arranged between adjacent battery cells and other locations in a battery pack that accommodates multiple battery cells, particularly a thermal insulation material using a porous structure such as an aerogel.

### RELATED ART

Hybrid vehicles and electric vehicles are equipped with battery packs that accommodate multiple battery cells. In a battery pack, a battery module formed by stacking multiple battery cells is accommodated in a housing in a state of being fixed by fastening members from both sides in the stacking direction. A thermal insulation material is arranged between adjacent battery cells and other locations to suppress heat transfer and suppress thermal runaway in case of abnormal heat generation in the battery cells. Battery cells expand and contract with charging and discharging. Therefore, it is desirable for the thermal insulation material arranged between battery cells to deform in response to the expansion and contraction of the battery cells and maintain thermal insulation properties. To be more specific, in a case where a battery cell is charged and expands, it is necessary for the thermal insulation material to become thinner under the compressive force while simultaneously generating a reaction force at or above a certain value to press against the battery cell, thereby avoiding misalignment of the thermal insulation material. Additionally, in a case where a battery cell is discharged and contracts (returning to the original thickness), it is necessary for the thermal insulation material to restore thickness as well. Silica aerogel or the like with low thermal conductivity is known as a material for the thermal insulation material. For example, Patent Literature 1 (Japanese Patent Application Laid-Open No. 2021-165387) describes aerogel powder composed of an aerogel, which is a hydrolyzed condensate of a silane compound, as aerogel powder that excels in flexibility and resistance to destruction against compressive force. The raw material silane compound satisfies 0≤Qx≤70, 30≤Tx≤100, 0≤Dx<30 (where Qx+Tx+Dx=100) in a case where the mass percentages of tetrafunctional silane compound, trifunctional silane compound, and bifunctional silane compound are denoted as Qx, Tx, and Dx in order. Patent Literature 2 (Japanese Patent Application Laid-Open No. 2020-122544) describes a thermal insulation material having porous structures in which multiple primary particles are connected to form skeletons with pores between the skeletons, and a binder, wherein the volume ratio of voids existing between the porous structures is set to 10% or more and 55% or less.

The aforementioned Patent Literature 1 describes using specific silane compounds as raw materials for the purpose of improving the flexibility of the aerogel powder itself and the resistance to destruction during processing. However, as mentioned in paragraph of the same literature that applications of aerogel powder include filling in thermal insulation windows and thermal insulation building materials, Patent Literature 1 has not described pressure-molding aerogel powder for use as a thermal insulation material for battery pack. Thus, in Patent Literature 1, the deformability during compression, the reaction force generated, and the restorability to return to the original shape after load removal in the “pressure-molded body” of the aerogel powder have not been considered. In addition, there is no description suggesting the void ratio of the “pressure-molded body”.

On the other hand, the thermal insulation material described in the aforementioned Patent Literature 2 is manufactured by dispersing porous structures in a binder liquid to form a paint, adjusting the state of gas in the paint, and then applying and drying the paint on a substrate. In this manufacturing method, the shrinkage strain during drying is reduced and the occurrence of cracks is suppressed by actively allowing voids to exist between the porous structures. The thermal insulation material described in Patent Literature 2 is not a “pressure-molded body” obtained by pressure-molding powder of porous structures. The volume ratio of voids specified in Patent Literature 2 is determined for the purpose of reducing shrinkage strain during paint drying, and does not satisfy the properties required for a thermal insulation material for battery pack.

The disclosure provides a thermal insulation material for battery pack that excels in deformability against compression and restorability after load removal, using a pressure-molded body of a composition having powder of porous structures, and a manufacturing method thereof.

### SUMMARY

(1) A thermal insulation material for battery pack of the disclosure (hereinafter may be referred to simply as “the thermal insulation material of the disclosure”) includes a pressure-molded body of a composition having powder of a porous structure in which multiple primary particles are connected to form skeletons and which has pores between the skeletons. The thermal insulation material for battery pack is characterized in that the porous structure is manufactured by a sol-gel reaction of a solution having two or more types of silane compounds with different numbers of siloxane bonds; the powder of the porous structure includes particles with different shapes and sizes obtained by subjecting the porous structure to a grinding process; a content of the powder of the porous structure in the composition is 65 mass % or more in a case where a solid content of the composition is 100 mass %; and a void ratio of the pressure-molded body is 20% or less.

For example, in a case where the powder of the porous structure includes spherical particles of similar sizes, in the pressure-molded body of such powder, the particles mainly contact each other at points and are regularly filled. As a result, the rigidity of the filled particles increases, and the reaction force against the compressive force from the outside becomes large, so the change in thickness when compressed is extremely small. In contrast, the powder of the porous structure used in the thermal insulation material of the disclosure is obtained by subjecting the porous structure to a grinding process, and includes particles with different shapes and sizes. In the pressure-molded body of the powder including such irregularly shaped and sized particles, the particles contact each other not only at points but also at lines or surfaces, and there is no regularity in the arrangement pattern. In this case, when compressed from the outside, the particles move so as to shift against each other, resulting in a relatively large deformation amount in the thickness direction. Additionally, if voids exist in the pressure-molded body, the particles move more easily, leading to an even larger deformation amount.

Furthermore, the porous structure is manufactured by a sol-gel reaction of a solution having two or more types of silane compounds with different numbers of siloxane bonds. In this specification, the siloxane bond of a silane compound refers to the bond between a silicon atom (Si) and an oxygen atom (O) (Si—O bond). Then, the number of siloxane bonds is the number of oxygen atoms bonded to a single silicon atom, and the silane compounds are classified into four types with 1 to 4 siloxane bonds. Based on the finding that the number of siloxane bonds in silane compounds affects the elasticity of the manufactured porous structure, the inventors realized a porous structure with desired elasticity, more specifically, a porous structure that deforms while generating a desired reaction force during compression and has restorability to return to the original shape after load removal, by mixing and using multiple silane compounds with different numbers of siloxane bonds. Then, by subjecting the obtained porous structure to a grinding process and using powder including particles with different shapes and sizes, a thermal insulation material capable of deforming in response to even slight expansion of battery cells during charging was realized. Thus, the thermal insulation material of the disclosure excels in deformability against compression and restorability after load removal. According to the thermal insulation material of the disclosure, even if battery cells expand and contract, high thermal insulation properties can be maintained with less likelihood of misalignment and other issues.
(2) In the above configuration, the powder of the porous structure may have an average particle diameter of 30 μm or more and 150 μm or less. According to this configuration, it is easier to achieve the desired filling state of the particles of the porous structure.
(3) In any of the above configurations, in the pressure-molded body, particles of the porous structure may be randomly stacked. According to this configuration, the particles of the porous structure contact each other at points, lines, surfaces, etc., making it easier for the particles to move to shift against each other when compressed from the outside. Therefore, the deformation amount in the thickness direction becomes larger.
(4) In any of the above configurations, the silane compounds may be a tetrafunctional silane compound and a trifunctional silane compound, or a tetrafunctional silane compound and a monofunctional silane compound. In this specification, a tetrafunctional silane compound refers to a silane compound with four siloxane bonds. Similarly, a trifunctional silane compound refers to a silane compound with three siloxane bonds, a bifunctional silane compound refers to a silane compound with two siloxane bonds, and a monofunctional silane compound refers to a silane compound with one siloxane bond. This configuration is suitable for manufacturing a porous structure with desired elasticity.
(5) In the configuration of (4) above, in a case where the silane compounds are the tetrafunctional silane compound and the trifunctional silane compound, a content ratio of the trifunctional silane compound may be 50 mass % or more in a case where a total of the silane compounds is 100 mass %. By increasing the content ratio of the trifunctional silane compound, the elastic deformation amount of the obtained porous structure can be increased.
(6) In the configuration of (4) above, in a case where the silane compounds are the tetrafunctional silane compound and the monofunctional silane compound, a content ratio of the monofunctional silane compound may be 10 mass % or more and less than 40 mass % in a case where a total of the silane compounds is 100 mass %. If the content ratio of the monofunctional silane compound becomes less than 10 mass %, the elastic deformation amount of the obtained porous structure becomes small, and if the content ratio becomes 40 mass % or more, the skeletal strength of the porous structure decreases.
(7) In any of the above configurations, the composition may include one or more types selected from infrared shielding particles, inorganic fibers, and a dispersant. According to this configuration, the pressure-molded body (thermal insulation material) includes one or more types selected from infrared shielding particles, inorganic fibers, and a dispersant.

The thermal insulation material using the porous structure can achieve high thermal insulation effects mainly by suppressing conduction and convection among the three forms of heat transfer (conduction, convection, and radiation). Here, radiation is a phenomenon in which heat moves by electromagnetic waves, and the higher the temperature, the greater the radiant energy emitted. Therefore, in a high-temperature atmosphere, radiation becomes the main factor of heat transfer. Thus, by using infrared shielding particles that can suppress heat transfer due to radiation in combination, it is possible to suppress heat transfer by radiation in addition to conduction and convection, and realize high thermal insulation properties not only at room temperature but also at high temperatures of 500° C. or higher. In a case where the pressure-molded body has inorganic fibers, the mechanical strength of the pressure-molded body improves, and the detachment of particles from the porous structure can be suppressed. The porous structure is also difficult to mix with water and disperse. Therefore, in the case of using water during the grinding process, adding a dispersant with amphiphilic properties can improve the dispersibility of the porous structure. As a result, the porous structure can be ground to a desired state. In this case, the composition has the powder of the porous structure and the dispersant, and is pressure-molded directly to become a pressure-molded body.
(8) In any of the above configurations, the porous structure may be a silica aerogel. The silica aerogel exhibits excellent thermal insulation properties due to good balance between the size of the skeletons and the size of the pores.
(9) In any of the above configurations, the composition may not have a binder that binds constituent components of the pressure-molded body. According to this configuration, in the pressure-molded body, it is easier to achieve the desired filling state and void ratio of the particles of the porous structure.
(10) The manufacturing method of the thermal insulation material for battery pack of the disclosure is one form of the manufacturing method of the thermal insulation material for battery pack with any of the above configurations, and is characterized in including: a first process of manufacturing powder of the porous structure including particles with different shapes and sizes by subjecting a composition, which includes the porous structure manufactured by a sol-gel reaction of a solution having two or more types of silane compounds with different numbers of siloxane bonds, a dispersant, and water, to a grinding process; and a second process of placing the composition after the grinding process into a mold, and pressure-molding the composition.

In the manufacturing method of the thermal insulation material for battery pack of the disclosure (hereinafter may be referred to simply as “the manufacturing method of the disclosure”), the porous structure is subjected to the grinding process using a dispersant (first process). This can improve the dispersibility of the porous structure, and can grind the porous structure to a desired state to manufacture powder including particles with different shapes and sizes.

Additionally, in the second process, the conditions during pressure-molding can be adjusted to set the void ratio of the pressure-molded body to 20% or less. According to the manufacturing method of the disclosure, the thermal insulation material for battery pack of the disclosure can be easily manufactured.
(11) In the configuration of (10) above, the composition in the first process may include one or more types selected from infrared shielding particles and inorganic fibers. In this configuration, in a case of including one or more types selected from infrared shielding particles and inorganic fibers (hereinafter may be referred to as “infrared shielding particles, etc.”) in the pressure-molded body (thermal insulation material), these are added to the porous structure, etc. to form a composition, and then subjected to a grinding process. Since the infrared shielding particles and inorganic fibers are harder than the porous structure, the infrared shielding particles and inorganic fibers are hardly ground under the conditions that grind the porous structure. According to this configuration, by adding the infrared shielding particles, etc. to the porous structure and dispersing the infrared shielding particles, etc. during the grinding process, there is no need to separately mix and disperse the infrared shielding particles, etc., resulting in fewer processes in processing. Therefore, production efficiency can be improved, which also leads to improved quality of the thermal insulation material.

According to this configuration, a pressure-molded body having the infrared shielding particles, etc. is manufactured. Similar to the configuration of (7) above, when the infrared shielding particles are included in the pressure-molded body, it is possible to suppress heat transfer by radiation in addition to conduction and convection, and realize high thermal insulation properties from room temperature to high temperatures of 500° C. or higher. When the inorganic fibers are included in the pressure-molded body, the mechanical strength of the pressure-molded body improves, and the detachment of particles from the porous structure can be suppressed.

The thermal insulation material for battery pack of the disclosure excels in deformability against compression and restorability after load removal. Therefore, even when battery cells expand and contract, misalignment and other issues are less likely to occur, and high thermal insulation properties can be maintained. According to the manufacturing method of the thermal insulation material for battery pack of the disclosure, the dispersibility of the porous structures in the grinding process can be improved, making it easy to manufacture the powder of the porous structures including particles with different shapes and sizes. As a result, the thermal insulation material for battery pack of the disclosure can be manufactured easily.

### BRIEF DESCRIPTION OF DRAWINGS

FIG. 1 is a schematic diagram showing the filling state of particles of the porous structure in the thermal insulation material of the disclosure.

FIG. 2 is a cross-sectional SEM image of the sample of Example 1 (200× magnification).

### DESCRIPTION OF EMBODIMENTS

The thermal insulation material for battery pack of the disclosure and the manufacturing method thereof will be described in detail below. The thermal insulation material of the disclosure is not limited to the following forms, and can be implemented in various forms with modifications and improvements that can be made by those skilled in the art within the scope that does not deviate from the gist of the disclosure.

### Thermal Insulation Material for Battery Pack

A pressure-molded body constituting the thermal insulation material for battery pack of the disclosure is manufactured by pressure-molding a composition having powder of porous structures.

### [Porous Structure]

The porous structure includes skeletons formed by connecting multiple primary particles, and has pores between the skeletons. The diameter of the primary particles forming the skeletons is preferably about 2 nm to 5 nm, and the size of the pores formed between the skeletons is preferably about 10 nm to 50 nm. In a case where many of the pores are so-called mesopores with a size of 50 nm or less, the mesopores are smaller than the mean free path of air, so the convection of air is restricted and the heat transfer is inhibited.

### [Manufacturing Method of Porous Structure]

The porous structure is manufactured by a sol-gel reaction of a solution having two or more types of silane compounds with different numbers of siloxane bonds (hereinafter, may be referred to as “silane compound-containing solution”). The silane compounds may include compounds with different numbers of siloxane bonds, and may also include multiple types of compounds with the same number of siloxane bonds. The silane compound-containing solution can be prepared by adding compounds appropriately selected from tetrafunctional silane compounds, trifunctional silane compounds, bifunctional silane compounds, and monofunctional silane compounds to the solution. In addition, when a catalyst is added to an aqueous solution of sodium silicate, silane compounds with different numbers of siloxane bonds are generated depending on the pH of the aqueous solution, the molar ratio of SiO₂ to Na₂O, and the type and concentration of the catalyst. Therefore, the silane compound-containing solution may be prepared using sodium silicate as a starting material and utilizing the hydrolysis reaction thereof. From the viewpoint of increasing the elastic deformation amount of the resulting porous structure, it is desirable that the silane compounds are in a form including tetrafunctional silane compounds and trifunctional silane compounds, or in a form including tetrafunctional silane compounds and monofunctional silane compounds.

Among these, in the former form, it is desirable that the content ratio of the trifunctional silane compounds is 50 mass % or more in a case where the total amount of silane compounds is 100 mass %. It is more preferable to make the content ratio 60 mass % or more, and even more preferably 65 mass % or more. When the content ratio of the trifunctional silane compounds is increased, the ratio of —O—Si—O— bonds decreases in the resulting porous structure, making it possible to increase the elastic deformation amount of the porous structure. It should be noted that, to achieve the effect of mixing silane compounds with different numbers of siloxane bonds, it is desirable that the content ratio of the tetrafunctional silane compounds in this form is at least 20 mass % or more in a case where the total amount of silane compounds is 100 mass %.

In the latter form, it is desirable that the content ratio of the monofunctional silane compounds is 10 mass % or more in a case where the total amount of silane compounds is 100 mass %. It is more preferable to make the content ratio 15 mass % or more. When the content ratio of the monofunctional silane compounds becomes less than 10 mass %, the elastic deformation amount of the resulting porous structure becomes small. In addition, from the viewpoint of suppressing a decrease in the skeletal strength of the porous structure, it is desirable that the content ratio of the monofunctional silane compounds is less than 40 mass % in a case where the total amount of silane compounds is 100 mass %. It is more preferable to make the content ratio 30 mass % or less.

The composition of the silane compounds used in the manufacture of the porous structure can be analyzed by a DD (Dipolar Decoupling) method using solid-state²⁹Si-NMR. That is, in the solid-state²⁹Si-NMR spectrum of the porous structure, the existence ratios of Q units, T units, D units, and M units, calculated from the signal areas of Q units, which are silicon atoms bonded to four oxygen atoms, T units, which are silicon atoms bonded to three oxygen atoms, D units, which are silicon atoms bonded to two oxygen atoms, and M units, which are silicon atoms bonded to one oxygen atom, correspond to the content ratios of tetrafunctional silane compounds, trifunctional silane compounds, bifunctional silane compounds, and monofunctional silane compounds included in the silane compound-containing solution.

As tetrafunctional silane compounds, tetraalkoxysilanes, tetraacetoxysilanes, etc. can be mentioned. It is desirable that the number of carbon atoms in the alkoxy group of tetraalkoxysilanes is 1 to 9. For example, tetramethoxysilane, tetraethoxysilane, tetrapropoxysilane, tetraisopropoxysilane, etc. can be mentioned. As trifunctional silane compounds, trialkoxysilanes, triacetoxysilanes, etc. can be mentioned. It is desirable that the number of carbon atoms in the alkoxy group of trialkoxysilanes is 1 to 9. For example, methyltrimethoxysilane, ethyltrimethoxysilane, propyltrimethoxysilane, hexyltrimethoxysilane, octyltrimethoxysilane, methyltriethoxysilane, ethyltriethoxysilane, propyltriethoxysilane, pentyltriethoxysilane, hexyltriethoxysilane, octyltriethoxysilane, etc. can be mentioned. As bifunctional silane compounds, dialkoxysilanes, diacetoxysilanes, etc. can be mentioned. It is desirable that the number of carbon atoms in the alkoxy group of dialkoxysilanes is 1 to 9. For example, dimethyldimethoxysilane, diethyldimethoxysilane, diisobutyldimethoxysilane, etc. can be mentioned. As monofunctional silane compounds, methoxytrimethylsilanes, isopropoxytrimethylsilanes, ethoxytrimethylsilanes, tert-butoxytrimethylsilanes, ethoxytriethylsilanes, methoxydimethyl(phenyl)silanes, trimethyl(vinyloxy)silanes, isopropenyloxytrimethylsilanes, etc. can be mentioned.

The manufacturing method of the porous structure utilizing a sol-gel reaction is not particularly limited, but the porous structure can be manufactured through, for example, a sol formation process, a gelation process, and a drying process. In the case of performing the drying process at normal pressure, a solvent replacement process may be implemented before the drying process to replace the moisture adhering to the gel with an organic solvent that can be dried at normal pressure. First, in the sol formation process, a predetermined silane compound is added to an aqueous solution including an acid catalyst and hydrolyzed to generate a sol. If necessary, a surfactant, a water-soluble oligomer having both polar and non-polar components in the side chain, etc. may be added. It should be noted that in the case of using sodium silicate as a starting material, a sol may be generated by adding an acid catalyst to an aqueous solution of sodium silicate and hydrolyzing the solution under a predetermined pH. Next, in the gelation process, a basic catalyst is added to the generated sol to polycondense and gelate the sol. After adding the basic catalyst, it is preferable to let the solution cure by leaving the solution under heating at about 80° C. to 120° C. to promote the polycondensation reaction. Then, in the drying process, the generated gel is dried. The drying method may be either a supercritical drying method or a non-supercritical drying method (normal pressure drying method, freeze drying method). The resulting porous structure may be subjected to a grinding process of the disclosure directly, that is, a grinding process to make the porous structure into desired powder including particles with different shapes and sizes, or may be subjected to the grinding process of the disclosure after preliminary grinding.

As the porous structure, a silica aerogel can be mentioned. Depending on the difference in drying methods when manufacturing the aerogel, the aerogel dried at normal pressure may be called “xerogel” and the aerogel dried under supercritical conditions may be called “aerogel”. However, in this specification, both are referred to as “aerogel”. A silica aerogel is more preferable for the balance between the size of the skeletons and the size of the pores.

### [Powder of Porous Structure]

The powder of the porous structure constituting the pressure-molded body includes particles with different shapes and sizes, obtained by subjecting the porous structure manufactured by the aforementioned sol-gel method to the grinding process. For the grinding process, a media-less grinding and mixing device such as a jet mill, a stirrer, etc. may be used. Although the porous structure has various shapes due to the grinding process, it is desirable to have shapes other than spherical.

It is desirable that the average particle diameter of the powder of the porous structure is 30 μm or more, from the viewpoint of increasing the pore volume and enhancing thermal insulation properties. Powder with an average particle diameter of less than 30 μm is not only difficult to obtain through the grinding process, but also tends to create fine voids between particles, which may make the pressure-molded body brittle. A preferable average particle diameter is 50 μm or more. On the other hand, from the viewpoint of ease of molding into a sheet form and suppression of particle detachment, it is desirable that the average particle diameter is 150 μm or less. Powder with an average particle diameter exceeding 150 μm is less likely to create voids between particles, but the size of the voids tends to become larger. A preferable average particle diameter is 120 μm or less. For the average particle diameter of the powder of the porous structure, the median diameter (D₅₀) obtained from the volume-based particle size distribution measured by a laser diffraction/scattering method may be adopted.

### [Composition]

The composition having the powder of the porous structure may be composed solely of the powder of the porous structure, or may include other components to the extent that the other components do not hinder the effects achieved by the disclosure. From the viewpoint of ensuring the desired thermal insulation properties in the pressure-molded body, the content of the powder of the porous structure in the composition is set to 65 mass % or more in a case where the solid content of the composition is 100 mass %. It is preferable to set the content to 70 mass % or more. Here, the solid content refers to components excluding volatile substances such as organic solvents and water. As other components, for example, infrared shielding particles, inorganic fibers, a dispersant, reinforcing inorganic particles, a flame retardant, etc. can be mentioned. It should be noted that, from the viewpoint of easily achieving the desired filling state and void ratio of the particles of the porous structure in the pressure-molded body, it is desirable that the composition does not have a binder that binds the constituent components of the pressure-molded body such as the particles of the porous structure.

### (1) Infrared Shielding Particles

The infrared shielding particles contribute to improving thermal insulation properties, especially at high temperatures, by absorbing heat from the heat source and re-emitting the same from the surface on the heat source side to block radiant heat from the heat source. From the viewpoint of filling the gaps (voids) between the porous structures and suppressing connection between the infrared shielding particles themselves and with other components to prevent the formation of heat transfer path, it is desirable that the particle diameter of the infrared shielding particles is relatively small. However, if the particle diameter is too small, it becomes difficult for infrared rays to hit the particles, and furthermore, the scattering of infrared rays becomes insufficient, making it difficult to achieve the effect of blocking radiant heat. From this viewpoint, it suffices if the average particle diameter of the infrared shielding particles is 0.3 μm or more and 22 μm or less. The shape of the infrared shielding particles is not particularly limited, and may be spherical, flat, or any other shape. As for the average particle diameter of the infrared shielding particles, similar to the powder of the porous structure, the median diameter (D₅₀) obtained from the volume-based particle size distribution measured by a laser diffraction/scattering method may be adopted. In the case of using commercially available products, catalog values may be adopted.

As the infrared shielding particles, particles of a single type selected from silicon carbide, kaolinite, montmorillonite, titanium oxide, silicon nitride, mica, alumina, aluminum nitride, boron carbide, iron oxide, magnesium oxide, tin oxide, zinc oxide, tantalum oxide, manganese ferrite, manganese oxide, nickel oxide, nickel, silver oxide, silver, bismuth oxide, carbon black, graphite, titanium, iron titanium oxide, zirconium, zirconia, zirconium silicate, barium titanate, manganese dioxide, chromium oxide, titanium carbide, tungsten carbide, tungsten oxide, niobium oxide, indium tin oxide, and cerium oxide, or particles of a mixture of two or more types selected from these can be mentioned. Among these, from the viewpoint of enhancing the effect of blocking radiant heat, it is desirable that the infrared shielding particles include high-emissivity particles with an emissivity of 0.6 or higher in the infrared wavelength region. As the high-emissivity particles, silicon carbide, kaolinite, silicon nitride, mica, alumina, zirconia, aluminum nitride, zirconium silicate, cerium oxide, boron carbide, manganese oxide, tin oxide, iron oxide, etc. can be mentioned. Additionally, from the viewpoint of enhancing the effect of blocking radiant heat by scattering incident infrared rays, it is also effective to include particles with a high refractive index in the infrared wavelength region. For example, high-refractive-index particles with a refractive index of 2.0 or higher in the visible light wavelength region are preferable. As the high-refractive-index particles, silicon carbide, titanium oxide, zirconia, silicon nitride, aluminum nitride, zinc oxide, tantalum oxide, tungsten oxide, niobium oxide, cerium oxide, manganese oxide, tin oxide, bismuth oxide, iron oxide, barium titanate, etc. can be mentioned.

For example, silicon carbide, titanium oxide, silicon nitride, mica, alumina, aluminum nitride, boron carbide, iron oxide, magnesium oxide, etc. have a relatively large specific heat, resulting in large heat capacities and making the particles themselves less likely to heat up. In this respect, the infrared shielding particles also contribute to improving the thermal insulation properties of the pressure-molded body (thermal insulation material). Additionally, the high heat resistance also contributes to improving the heat resistance of the pressure-molded body. In particular, silicon carbide is preferable for silicon carbide exhibits minimal increase in thermal conductivity even in a high-temperature atmosphere of about 800° C.

### (2) Inorganic Fibers

The inorganic fibers exist physically entangled around the porous structure, thereby improving the mechanical strength of the pressure-molded body and suppressing the detachment of particles from the porous structure. The type of the inorganic fibers is not particularly limited, but considering heat resistance and mechanical strength, ceramic fibers such as glass fibers and alumina fibers are preferable. It is desirable that the length of the inorganic fibers is 16 mm or less, taking into account both the reinforcing effect and the suppression of formation of heat transfer path.

### (3) Dispersant

The dispersant may be used when performing the grinding process on the porous structure. Suitable dispersants include surfactants, water-soluble oligomers having both polar and non-polar components in the side chains, etc. The surfactants include ionic surfactants (cationic surfactants, anionic surfactants, amphoteric surfactants) and non-ionic surfactants. For example, using an ionic surfactant can increase the viscosity of the composition or stabilize the dispersion of the materials such as the porous structure in the composition, even in a relatively small amount. As the ionic surfactants, sodium carboxymethyl cellulose (CMC-Na), polycarboxylic acid amine salts, polycarboxylic acid ammonium salts, polycarboxylic acid sodium salts, TEMPO-oxidized cellulose nanofibers (CNF-Na), etc. can be mentioned. Using a non-ionic surfactant makes it easier for materials such as the porous structure to be incorporated into the solvent when preparing the composition. Additionally, when these materials aggregate or separate in the composition, these materials become easier to re-disperse, or the solvent becomes easier to discharge during pressure-molding. As the non-ionic surfactants, polyethylene oxide (PEO), polyvinyl alcohol (PVA), etc. can be mentioned.

### (4) Reinforcing Inorganic Particles

From the viewpoint of improving the mechanical strength of the pressure-molded body, reinforcing inorganic particles may be included in the composition. The type of the reinforcing inorganic particles is not particularly limited, and for example, particles with relatively high hardness and large specific surface area can be used, such as precipitated silica, gel silica, fused silica, wollastonite, potassium titanate, magnesium silicate, glass flakes, calcium carbonate, and barium sulfate.

### (5) Flame Retardant

From the viewpoint of imparting flame retardancy to the pressure-molded body, the flame retardant may be included in the composition. Known flame retardants such as halogen-based, phosphorus-based, or metal hydroxide-based flame retardants may be used. Considering environmental impact, it is desirable to use phosphorus-based flame retardants. As the phosphorus-based flame retardants, ammonium polyphosphate, red phosphorus, phosphate esters, etc. can be mentioned. Among these, flame retardants that are insoluble in water or coated with water-resistant resin are preferable because the flame retardants are less likely to leach out even in contact with moisture during use. For example, ammonium polyphosphate or resin-coated ammonium polyphosphate is preferable.

### [Pressure-Molded Body]

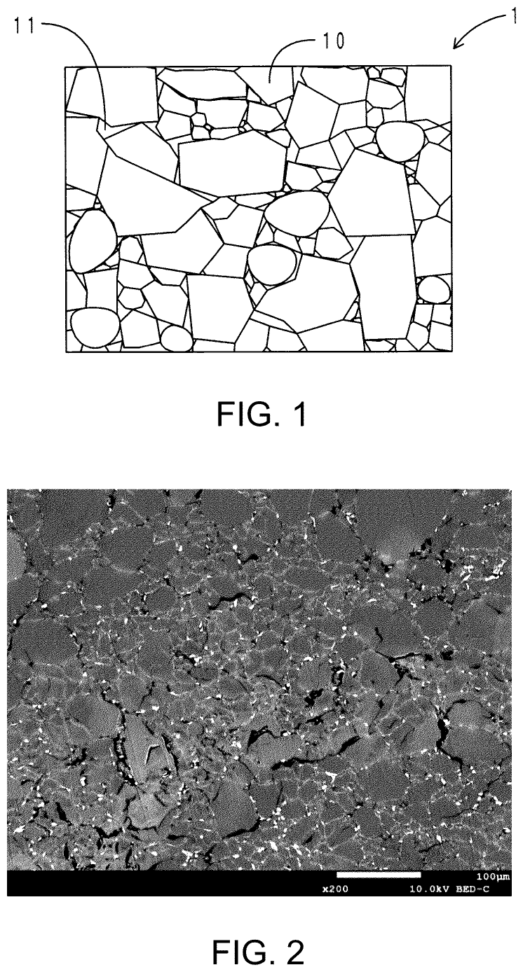

In the pressure-molded body formed by pressure-molding the composition having the powder of the porous structure, it is desirable that the particles of the porous structure are randomly stacked. FIG. 1 shows a schematic diagram of the filling state of particles of the porous structure in the thermal insulation material of the disclosure. The schematic diagram shown in FIG. 1 illustrates a cross-section in the thickness direction of the thermal insulation material (pressure-molded body). In FIG. 1, hatching of the particles of the porous structure is omitted. As shown in FIG. 1, in the thermal insulation material 1, multiple particles 10 of the porous structure are arranged in a stacked manner. Many of the multiple particles 10 of the porous structure have shapes other than spherical, and the individual shapes and sizes differ. The filling state of the particles 10 of the porous structure is similar to the “random stacking” form seen in stone walls of Japanese castles. “Random stacking” is one of the stone stacking methods, in which natural stones or roughly split stones are directly stacked without processing. Between the particles 10 of the porous structure and the particles 10 of the porous structure, there are slight voids 11. The particles 10 of the porous structure are in contact with each other at points, lines, and/or surfaces, or combinations thereof, and there is no regularity in the arrangement pattern. Thus, when compressed from the outside in the thickness direction, the particles 10 of the porous structure move and deform so as to shift against each other. Additionally, since the particles 10 of the porous structure possess elasticity, the particles 10 deform while generating the desired reaction force during compression of the thermal insulation material 1, and return to the original shape upon load removal.

The void amount in the pressure-molded body affects the thermal insulation properties. As the voids increase, that is, as the void ratio increases, heat transfer due to the convection of air becomes larger, resulting in a decrease in thermal insulation properties. Therefore, considering only thermal insulation properties which are the original purpose, it is desirable to form no voids. However, if there are few voids, when compressed from the outside, the particles of the porous structure may become difficult to shift, potentially leading to a smaller deformation amount. Conversely, if there are too many voids, the contact points formed by points, lines, and/or surfaces, or combinations thereof, of the porous structure may decrease, making it difficult for the elasticity of the porous structure to be exhibited, potentially leading to a decrease in the recovery rate. Thus, in the thermal insulation material of the disclosure, considering the thermal insulation properties, deformability, and restorability, the void ratio is set to 20% or less. A preferable void ratio is 15% or less. The void ratio may be 0%, that is, no voids may be detected in the following measurement method.

The void ratio in the disclosure is a value obtained by capturing a cross-section in the thickness direction of the pressure-molded body using a scanning electron microscope (SEM), and then performing binary processing on the obtained cross-sectional image. The procedure is described below.
(1) First, a cross-sectional SEM image in the thickness direction of the pressure-molded body is captured at a magnification of 200×.
(2) Next, adjustment of contrast, noise removal, and binary processing are applied to the captured SEM image in this order. The CLAHE (Contrast Limited Adaptive Histogram Equalization) algorithm was used for adjustment of contrast. The parameters at this time were Contrast Limit: 2.0 and Grid Size: (8,8). The Non-Local Means Filter was used for noise removal. The parameters at this time were h: 40, Template Window Size: 23, and Search Window Size: 39. Here, h is the strength of filter, Template Window Size is the size of the portion to be searched, and Search Window Size is the size of the area to be searched. Adaptive binarization was used for binary processing. The parameters at this time were Block Size: 219 and C: 40. Here, Block Size is the range referenced when calculating the threshold value, and C is the correction of threshold value. The method for calculating the threshold value was set to the average value of the referenced range. Finally, to remove extremely small noise, structures smaller than 15 μm (32 pixels) were removed from the screen after binary processing.
(3) The structures remaining on the screen were considered as voids, and the void ratio was calculated by the following equation (I).

$$Void ratio ( \% ) = area of voids / area of the entire screen \times 100 \qquad ( I )$$

### Usage Form

The thermal insulation material of the disclosure may be composed solely of the pressure-molded body, or may include a substrate supporting the pressure-molded body, an outer covering material accommodating the pressure-molded body, etc. The substrate may be arranged on only one side in the thickness direction of the thermal insulation material, or may be arranged on both sides to sandwich the thermal insulation material. Additionally, a single sheet of substrate may be used to cover the thermal insulation material, using the substrate as an outer covering material. An adhesive layer may be interposed between the thermal insulation material and the substrate. The adhesive layer may include, in addition to the adhesive component, a flame retardant, etc.

The materials of the substrate include fabric, resin, paper, steel sheet, and so on. As the fibers constituting the fabric, glass fibers, rock wool, ceramic fibers, alumina fibers, silica fibers, carbon fibers, metal fibers, polyimide fibers, aramid fibers, polyphenylene sulfide (PPS) fibers, etc. can be mentioned. Known ceramic fibers include refractory ceramic fibers (RCF), polycrystalline alumina fibers (Polycrystalline Wool: PCW), and alkaline earth silicate (AES) fibers. Among these, AES fibers are safer for AES fibers have biosolubility. As the resin, polyethylene terephthalate (PET), polyimide, polyamide, PPS, etc. can be mentioned. As the paper, pulp, a composite material of pulp and magnesium silicate, etc. can be mentioned. As the steel sheet, galvalume steel sheet (registered trademark), galvanized sheet, stainless steel (SUS) sheet, iron sheet, titanium sheet, etc. can be mentioned. The shape of the substrate is not particularly limited, and includes woven fabric, non-woven fabric, film, sheet, etc. The substrate may include a single layer or a laminate of two or more layers of the same or different materials stacked on each other.

For example, fabric (woven fabric) or non-woven fabric manufactured from inorganic fibers such as glass fibers and metal fibers, like glass cloth, and fire-resistant thermal insulation paper manufactured as a composite material of pulp and magnesium silicate, have relatively low thermal conductivity and high shape retention in a high-temperature atmosphere. Moreover, adopting a fire-resistant substrate further improves safety. A highly heat-resistant substrate may be manufactured from glass fibers, rock wool, ceramic fibers, polyimide, PPS, etc., which specifically include glass fiber non-woven fabric, glass cloth, aluminum glass cloth, AES wool paper, polyimide fiber non-woven fabric, etc.

### Manufacturing Method of Thermal Insulation Material for Battery Pack

The manufacturing method of the thermal insulation material for battery pack of the disclosure is a form of the previously described manufacturing method of the thermal insulation material for battery pack of the disclosure, and includes a first process and a second process. Each process will be described in order.

### [First Process]

This process is a process of manufacturing powder of a porous structure including particles with different shapes and sizes by grinding a composition including a porous structure manufactured by a sol-gel reaction of a solution containing two or more types of silane compounds with different numbers of siloxane bonds, a dispersant, and water. The silane compounds and the manufacturing method of the porous structure utilizing the sol-gel reaction are as described previously. The porous structure may be in the as-manufactured state or may have been pre-ground after manufacturing (both including purchased products). The grinding process can be performed using a media-less grinding and mixing device, a stirrer, or the like.

As for the dispersant, as mentioned earlier, a surfactant, a water-soluble oligomer having both polar and non-polar components in the side chain, etc. may be used. It should be noted that if a dispersant is present in the pressure-molded body, there is a risk of forming a heat transfer path therethrough. Additionally, under high temperatures, organic components may decompose or degrade, potentially generating gas or causing cracks in the pressure-molded body. Therefore, considering the balance with exhibiting the dispersing function, it is desirable that the content of the dispersant is 5 mass % or less, and further 2 mass % or less, in a case where the solid content of the composition is 100 mass %.

In this process, one or more types selected from infrared shielding particles and inorganic fibers may be added to the composition and subjected to the grinding process. Since the infrared shielding particles and inorganic fibers are harder than the porous structure, the infrared shielding particles and inorganic fibers are hardly ground under the conditions that grind the porous structure. Therefore, by adding the infrared shielding particles, etc. to the composition and grinding the infrared shielding particles together with the porous structure, there is no need to separately mix and disperse the infrared shielding particles, etc., resulting in fewer processes in processing. This can improve production efficiency and lead to improved quality of the thermal insulation material.

### [Second Process]

This process is a process of placing the composition after the grinding process into a mold and pressure-molding the composition. The conditions for pressure-molding may be appropriately determined so that the resulting pressure-molded body has the desired void ratio (20% or less). For example, a pressure of about 0.1 MPa to 2.0 MPa surface pressure may be applied while heating at a temperature of about 100° C. to 160° C.

### [Other Forms]

A form has been described that, in the aforementioned first process, the infrared shielding particles, etc. are added to the composition and ground together with the porous structure. However, in a case where the infrared shielding particles, etc. are included in the pressure-molded body, the infrared shielding particles, etc. may be separately mixed with the composition after grinding the porous structure, and then subjected to pressure-molding in the second process.

### EXAMPLES

Next, the disclosure will be described more specifically with examples.

### Manufacture of Thermal Insulation Material Sample

### [Manufacture of Composition]

### (1) First Composition

First, water was weighed in a resin container, and a surfactant serving as a dispersant was added. The mixture was stirred at 800 rpm for 60 minutes using an air-driven blade stirrer to dissolve the surfactant in water. After stopping the stirring, silicon carbide (SiC) powder serving as infrared shielding particles was added, and further stirring was performed at 800 rpm for 15 minutes. While continuing the stirring, a silica aerogel serving as a porous structure was added and completely wetted in the liquid. Then, glass fibers serving as inorganic fibers were added, and a grinding process was performed by stirring at 800 rpm for 30 minutes. Subsequently, additional stirring was performed at 1000 rpm for 10 minutes to perform a second grinding process. In this manner, a composition including silica aerogel powder with an average particle diameter (D₅₀) of 70 μm was manufactured. The composition exhibited a clay-like state in which granules with a diameter of 5 mm or less were aggregated. The content of the silica aerogel powder in the composition was 73.7 mass % in a case where the solid content of the composition was 100 mass %. Similarly, the content of the surfactant in the composition was 2.9 mass %, the content of the silicon carbide powder was 15.1 mass %, and the content of the glass fibers was 8.3 mass %.

### (2) Second Composition

The second composition including silica aerogel powder with an average particle diameter (D₅₀) of 150 μm was manufactured in the same manner as the first composition, except that the duration of each of the two grinding processes was shortened. Specifically, the stirring time after adding the silica aerogel was set to 5 minutes, and the time of additional stirring was set to 5 minutes.

The details of the materials used are as follows.
Silica aerogel: Ground product of “Aerogel Particles P200” manufactured by Cabot Corporation, with an average particle diameter of 100 μm. This product was analyzed by a DD method using solid-state²⁹Si-NMR, at a MAS rotation speed of 10 kHz and a pulse delay time of 5 seconds. The result showed that the existence ratio of Q units was 78.3 mass % and the existence ratio of M units was 21.7 mass %. From this analysis result, it was confirmed that the silane compounds used in the manufacture of this product included 78.3 mass % tetrafunctional silane compound and 21.7 mass % monofunctional silane compound, based on 100 mass % of the total silane compounds.
Silicon carbide powder: “Fuji Random GC #4000” manufactured by Fuji Manufacturing Co., Ltd., with an average particle diameter of 5 μm.
Surfactant: Polyethylene oxide “PEO-8” manufactured by Sumitomo Seika Chemicals Co., Ltd., with a viscosity average molecular weight of 1.7 million to 2.2 million.
Glass fibers: “ECS03-615” manufactured by Central Glass Fiber Co., Ltd., with a length of 3 mm and a fiber diameter of 9 μm.

### [Manufacture of Pressure-molded Body]

The manufactured clay-like composition was pressure-molded as follows. First, a base was prepared by stacking a first spacer plate made of SUS on top of glass fiber paper. A 150 mm square injection hole was formed in the center of the first spacer plate. The manufactured composition was filled into the injection hole of the first spacer plate and molded into a square plate shape. Subsequently, the first spacer plate was removed, glass fiber paper was stacked on top, and then a second spacer plate was placed on top of that to manufacture a laminate including “glass fiber paper/composition/glass fiber paper/second spacer plate”. A 150 mm square injection hole was also formed in the center of the second spacer plate, similar to the first spacer plate, and the molded composition was accommodated in the injection hole of the second spacer plate. The thicknesses of the first spacer plate and the second spacer plate were adjusted so that the thermal insulation material sample had the desired void ratio.

Separately, a first plate material made of aluminum with a thickness of 5 mm and dimensions of 320 mm square, and a second plate material made of aluminum with a thickness of 1 mm and dimensions of 320 mm square were prepared. Multiple grooves were formed on one surface of the first plate material. Each of the multiple grooves was linear, with a width of 2.5 mm, a depth of 3 mm, and a length of 200 mm, formed in parallel at 5 mm intervals. Punching holes with a diameter of 1 mm were formed throughout the second plate material at 2 mm intervals. The second plate material was stacked on one surface side of the first plate material, and the laminate was placed on top of that. Then, the second plate material was placed on top of the laminate, and further the first plate material was stacked with one surface formed with the grooves on the second plate material side. In this state, pressure-molding was performed by hot pressing at a temperature of 165° C. and a load of about 980 kN for 10 minutes. Thereafter, these were cooled to room temperature (20° C.±5° C.), and the first plate material, the second plate material, the second spacer plate, and the upper and lower glass fiber paper were removed to obtain a square plate-shaped pressure-molded body. Seven types of pressure-molded bodies with different void ratios were manufactured by changing the thicknesses of the first spacer plate and the second spacer plate. The manufactured pressure-molded bodies were used as thermal insulation material samples.

The cross-sections in the thickness direction of the seven types of thermal insulation material samples were observed by SEM. As an example, FIG. 2 shows a cross-sectional SEM image (200× magnification) of the sample from Example 1. As shown in FIG. 2, in all samples, silica aerogel particles with different shapes and sizes were randomly stacked. Many of the silica aerogel particles had shapes other than spherical, and silicon carbide particles and glass fibers were arranged between the silica aerogel particles.

### Evaluation of Thermal Insulation Material Sample

### [Thermal Insulation Properties]

The thermal conductivity of the thermal insulation material samples at 600° C. was measured using a “Quick Thermal Conductivity Meter QTM-700” and a “High Temperature Probe PD-31N” manufactured by Kyoto Electronics Manufacturing Co., Ltd., as follows. First, two laminates with a thickness of about 20 mm were prepared by stacking the thermal insulation material samples. These laminates were placed one each above and below the probe to sandwich the probe, and a weight of about 5 kg, which was not heavy enough to crush the laminates, was placed on top before setting these in an electric furnace. Then, the temperature inside the electric furnace was raised to 600° C., and after the furnace temperature stabilized, the thermal conductivity was measured. In this example, cases where the measured thermal conductivity was less than 0.12 W/m·K were evaluated as passing (indicated by ∘ in Table 1 below), and cases where the thermal conductivity was 0.12 W/m·K or more were evaluated as failing (indicated by x in the same table).

### [Restorability]

A compression test was conducted using a Tensilon Universal Testing Machine “RTF1350” manufactured by A&D Company, Limited, by pressing the central part of the thermal insulation material sample (a square plate shape with dimensions of 150 mm in length, 150 mm in width, and arbitrary thickness) with a compression terminal having a diameter of 60 mm. The compression test was performed by reciprocating the compression terminal at a speed of 1 mm/min with an upper limit of compressive stress set at 2.0 MPa, and repeating 3 cycles where one cycle was defined as an interval in which the compressive stress changed from 0.02 MPa→2.0 MPa→0.02 MPa. Based on the data obtained from the compression test, a stress-compression ratio curve was created with the compression ratio on the horizontal axis and the compressive stress on the vertical axis. The compression ratio on the horizontal axis was a value calculated by the following equation (II).

$$Compression ratio ( \% ) = push - in amount ( mm ) of compression terminal after the compressive stress reaches 0.01 MPa during the pressing process in one cycle / thickness ( mm ) of thermal insulation material sample when the compressive stress reaches 0.01 MPa during the pressing process in one cycle \times 100 \qquad ( II )$$

In the stress-compression ratio curve of the second cycle, the index value for the restorability of the thermal insulation material sample was a value obtained by subtracting the compression ratio at the end of the cycle when the compressive stress was 0.02 MPa from the compression ratio when the compressive stress was 2.0 MPa. In this example, cases where the restorability index value was 10% or more were evaluated as passing (indicated by ∘ in Table 1 below), and cases where the restorability index value was less than 10% were evaluated as failing (indicated by x in the same table).

### [Evaluation Result]

Table 1 shows the evaluation results of the void ratio, average particle diameter of silica aerogel powder, thermal insulation properties, and restorability of the thermal insulation material samples.

TABLE 1

| | | | Example | Example | Example | Example | Example | Example | Comparative |
|---|---|---|---|---|---|---|---|---|---|
| | | | 1 | 2 | 3 | 4 | 5 | 6 | Example 1 |
| Composition | Powder of | Powder of | 73.7 | | | | | | |
| [unit is | porous | silica | | | | | | | |
| mass %] | structure | aerogel | | | | | | | |
| | Infrared | Silicon | 15.1 | | | | | | |
| | shielding | carbide | | | | | | | |
| | particles | | | | | | | | |
| | Inorganic | Glass | 8.3 | | | | | | |
| | fibers | fibers | | | | | | | |
| | Dispersant | Surfactant | 2.9 | | | | | | |
| Average particle diameter of powder of | | | 70 | | | | 150 | 70 | |
| silica aerogel [μm] | | | | | | | | | |
| Void ratio of pressure-molded body [%] | | | 1.7 | 3.4 | 7.4 | 15.0 | 8.0 | 0.0 | 25.0 |
| Evaluation | Thermal conductivity | | ∘ | ∘ | ∘ | ∘ | ∘ | ∘ | x |
| result | Restorability | Index | 43 | 39 | 26 | 10 | 22 | 12 | 8 |
| | | value [%] | | | | | | | |
| | | Evaluation | ∘ | ∘ | ∘ | ∘ | ∘ | ∘ | x |

As shown in Table 1, the samples of Examples 1 to 6 with a void ratio of 20% or less were confirmed to have excellent thermal insulation properties under high temperatures and high restorability. Although not shown in Table 1, these samples were also confirmed to have a large deformation amount (compression ratio). When comparing the samples of Examples 1 to 4, it was confirmed that as the void ratio increased, the recovery rate decreased. It is presumed that as the void ratio increases, the contact points between silica aerogel particles decrease, resulting in less friction between particles, and even though the voids are crushed by compression, the voids do not possess restorability, leading to a decrease in restorability. In addition, it was confirmed that restorability was exhibited even in the case of 0% void ratio, as in the sample of Example 6. In contrast, according to the sample of Comparative Example 1 with a void ratio of 25%, the results were inferior in both thermal insulation properties and restorability.

1. A thermal insulation material for battery pack, comprising a pressure-molded body of a composition having powder of a porous structure in which a plurality of primary particles are connected to form skeletons and which has pores between the skeletons,
wherein the porous structure is manufactured by a sol-gel reaction of a solution having two or more types of silane compounds with different numbers of siloxane bonds, and the powder of the porous structure comprises particles with different shapes and sizes obtained by subjecting the porous structure to a grinding process,
a content of the powder of the porous structure in the composition is 65 mass % or more in a case where a solid content of the composition is 100 mass %, and
a void ratio of the pressure-molded body is 20% or less.

2. The thermal insulation material for battery pack according to claim 1, wherein the powder of the porous structure has an average particle diameter of 30 μm or more and 150 μm or less.

3. The thermal insulation material for battery pack according to claim 1, wherein in the pressure-molded body, particles of the porous structure are randomly stacked.

4. The thermal insulation material for battery pack according to claim 1, wherein the silane compounds are a tetrafunctional silane compound and a trifunctional silane compound, or a tetrafunctional silane compound and a monofunctional silane compound.

5. The thermal insulation material for battery pack according to claim 4, wherein in a case where the silane compounds are the tetrafunctional silane compound and the trifunctional silane compound, a content ratio of the trifunctional silane compound is 50 mass % or more in a case where a total of the silane compounds is 100 mass %.

6. The thermal insulation material for battery pack according to claim 4, wherein in a case where the silane compounds are the tetrafunctional silane compound and the monofunctional silane compound, a content ratio of the monofunctional silane compound is 10 mass % or more and less than 40 mass % in a case where a total of the silane compounds is 100 mass %.

7. The thermal insulation material for battery pack according to claim 1, wherein the composition comprises one or more types selected from infrared shielding particles, inorganic fibers, and a dispersant.

8. The thermal insulation material for battery pack according to claim 1, wherein the porous structure is a silica aerogel.

9. The thermal insulation material for battery pack according to claim 1, wherein the composition does not comprise a binder that binds constituent components of the pressure-molded body.

10. A manufacturing method of the thermal insulation material for battery pack according to claim 1, comprising:
a first process of manufacturing powder of the porous structure comprising particles with different shapes and sizes by subjecting a composition, which comprises the porous structure manufactured by a sol-gel reaction of a solution having two or more types of silane compounds with different numbers of siloxane bonds, a dispersant, and water, to a grinding process; and
a second process of placing the composition after the grinding process into a mold, and pressure-molding the composition.

11. The manufacturing method of the thermal insulation material for battery pack according to claim 10, wherein the composition in the first process comprises one or more types selected from infrared shielding particles and inorganic fibers.
